(19) United States
(12) Patent Application Publication
(10) Pub. No.: US 2008/0124146 A1
(43) Pub. Date: May 29, 2008

(54) IMAGE FORMING APPARATUS

(75) Inventors: Sea Chul BAE, Paldal-gu (KR); Woong Jae Chang, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/761,451

(22) Filed: Jun. 12, 2007

(30) Foreign Application Priority Data
Nov. 27, 2006 (KR) 2006-117703

(51) Int. Cl. G03G 15/20

(52) U.S. Cl. 399/329

(57) ABSTRACT

An image forming apparatus includes a fixing belt which is rotatably mounted, a support roller which is in contact with an inner surface of the fixing belt to support the fixing belt, a press member which pressurizes a portion of the fixing belt toward a paper, and a press roller which is in pressure contact with the support roller and the press member, the fixing belt being positioned between the press roller and the support roller and between the press roller and the press member. At least one of the support roller and the press roller has a concave shape such that a diameter of both ends of the at least one of the support roller and the press roller is larger than a diameter of a middle portion, and the press member is formed with a curved portion which is convexly formed at a middle portion of the at least one of the support roller and the press roller.

### CROSS-REFERENCE TO RELATED APPLICATIONS

This application claims priority under 35 U.S.C. § 119(a) from Korean Patent Application No. 2006-0117703, filed on Nov. 27, 2006 in the Korean Intellectual Property Office, the disclosure of which is incorporated herein by reference.

### BACKGROUND OF THE INVENTION

1. Field of the Invention

The present general inventive concept relates to an image forming apparatus, and more particularly to an image forming apparatus which fixes an image on a paper by using a belt.

2. Description of the Related Art

Generally, an image forming apparatus is an apparatus that prints an image on a paper according to an inputted image signal. As one example of the image forming apparatus, an electro photographic image forming apparatus is configured such that a light beam is scanned to a photosensitive member that has been charged with an electric potential, to form an electrostatic latent image thereon. The electrostatic latent image is then developed to a toner image by using a toner, and the toner image is transferred onto a paper. The toner image is permanently fixed to the paper by heat and pressure while passing through a fixing device provided at the image forming apparatus.

A conventional toner image fixing device includes a heat roller which has a heating source therein, and a press roller which is in contact with the heat roller and forms a fixing nip at the contact portion between the rollers. When the paper with the transferred toner image is guided into the fixing nip between the heat roller and the press roller, both rotating while in pressure contact with each other, it is heated and pressed by the heat roller and the press roller with the result that the toner image is fixed on the paper.

However, the conventional toner image fixing device has a problem in that because it takes a large amount of time to heat the heat roller to a temperature adequate to fix the toner image, the image forming apparatus requires a long warm-up time to initiate the printing in actual practice. In addition, in order to improve the toner image fixing performance, the conventional toner image fixing device requires a wide fixing nip. Accordingly, diameters of the press roller and the heat roller should be increased, resulting in that the size of the image forming apparatus is enlarged.

To solve this problem, a toner image fixing method incorporating a belt appears to be disclosed in Japanese Patent Laid-open Publication No. 2006-146. The disclosed conventional toner image fixing device of the image forming apparatus includes a fixing roller which has a heating source therein, and a fixing belt which is supported by three rollers, and a press pad which pressurizes the fixing belt toward the fixing roller. One of the three rollers supporting the fixing belt (hereinafter, which will be called a “separated roller”) is in close contact with the fixing roller and forms a fixing nip with the press pad.

The above conventional belt type toner image fixing device provides that the fixing nip is formed in a wide region and the fixing performance can be improved. However, the conventional fixing device has a shortcoming that when a pressure distribution exerted on the fixing roller from the press pad or the separated roller is non-uniform, a slip phenomenon is generated between the fixing belt and the fixing roller, which results in contamination of the image on the paper or a wrinkling of the paper.

### SUMMARY OF THE INVENTION

The present general inventive concept provides an image forming apparatus which can improve image fixing performance while preventing contamination of an image transferred onto a paper or a wrinkling of the paper.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus including a fixing belt rotatably mounted, a support roller in contact with an inner surface of the fixing belt to support the fixing belt, a press member to pressurize a portion of the fixing belt toward a paper, and a press roller in pressure contact with the support roller and the press member. At least one of the support roller and the press roller has a concave shape such that a diameter of both ends of the at least one of the support roller and the press roller is larger than a diameter of a middle portion of the at least one of the support roller and the press roller, and the press member has a curved portion convexly formed at a middle portion thereof.

The image forming apparatus including a heat roller having a heat source to support the fixing belt together with the support roller. The press member is disposed between the support roller and the heat roller.

The support roller can be a driving roller to drive the fixing belt.

The foregoing and/or other aspects and utilities of the present general inventive concept may be achieved by providing an image forming apparatus including a fixing belt having an inner surface supported by a driving roller and a heat roller, a press member disposed between the driving roller and the heat roller to pressurize a portion of the fixing belt toward a paper, and a press roller in pressure contact with the driving roller and the press member, the fixing belt being positioned between the press roller and the driving roller and between the press roller and the press member. The press roller can have a concave shape such that a diameter of both ends of the press roller is larger than a diameter of a middle portion thereof, and the press member has a curved portion convexly formed at a middle portion thereof corresponding to the concave-shaped press roller.

The driving roller can have a concave shape such that a diameter of both ends of the driving roller is larger than a diameter of a middle portion of the driving roller.

The foregoing and/or other aspects and utilities of the present general inventive concept may also be achieved by providing an image forming apparatus including a fixing belt which is rotatably supported by a first roller and a second roller; and a press roller in pressure contact with the first roller and the second roller, the fixing belt being positioned between the press roller and the first and second rollers. The press roller can have a concave shape such that a diameter of both ends of the press roller is larger than a diameter of a middle portion thereof, and one of the first roller and the second roller, disposed upstream of a paper feeding direction with respect to the other of the first roller and the second roller, has a convex shape such that a diameter of a middle portion of the one of the first roller and the second roller is larger than a diameter of both ends thereof.

The other one of the first roller and the second roller disposed downstream of the paper feeding direction with respect to the one of the first roller and the second roller, has a concave shape such that a diameter of both ends of the other one of the first roller and the second roller is larger than a diameter of a middle portion thereof.

The foregoing and/or other aspects and utilities of the present general inventive concept may also be achieved by providing a fixing apparatus including a roller having a concave shape so that a diameter of ends of the roller is larger than a diameter of a middle portion of the roller, a member having a convex shape portion disposed opposite the roller that corresponds with the concave shape of the roller, and a belt interposed between and contacting both the roller and the member to transport the recording medium between the roller and the member.

The foregoing and/or other aspects and utilities of the present general inventive concept may also be achieved by providing an image forming apparatus including a frame, a fixing apparatus disposed proximate to the frame, the fixing apparatus including a roller having a concave shape so that a diameter of ends of the roller is larger than a diameter of a middle portion of the roller, a member having a convex shape portion deposed opposite the roller, the convex shape portion corresponding to the concave shape of the roller, and a belt interposed between the roller and the member to transport the recording medium between the roller and the member.

The foregoing and/or other aspects and utilities of the present general inventive concept may also be achieved by providing an image forming apparatus including a press roller having a concave shape along a length thereof, and a fixing belt rotatably mounted in pressing contact with the press roller at two portions thereof to receive a recording medium therebetween to fix a toner image on the recording medium, the fixing belt having a convex shape at one of the two portions thereof in a width direction extending along the length of the press roller to correspond with the concave shape of the press roller.

### BRIEF DESCRIPTION OF THE DRAWINGS

These and/or other aspects and utilities of the present general inventive concept will become apparent and more readily appreciated from the following description of the embodiments, taken in conjunction with the accompanying drawings, of which:

FIG. 1 is a sectional view illustrating of an image forming apparatus in accordance with an embodiment of the present general inventive concept;

FIG. 2 is a sectional view illustrating a fixing unit of an image forming apparatus illustrated in FIG. 1;

FIG. 3 is a plan view illustrating a press roller and a driving roller of a fixing unit illustrated in FIG. 2;

FIG. 4 is a plan view illustrating a press roller and a press member of a fixing unit illustrated in FIG. 2;

FIG. 5 is a sectional view illustrating a fixing unit of an image forming apparatus in accordance with another embodiment of the present general inventive concept;

FIG. 6 is a plan view illustrating an arrangement between a press roller and a roller in pressure contact with the press roller of a fixing unit illustrated in FIG. 5; and

FIG. 7 is a plan view illustrating an arrangement between the press roller and a roller in pressure contact with the press roller of a fixing unit illustrated in FIG. 5.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

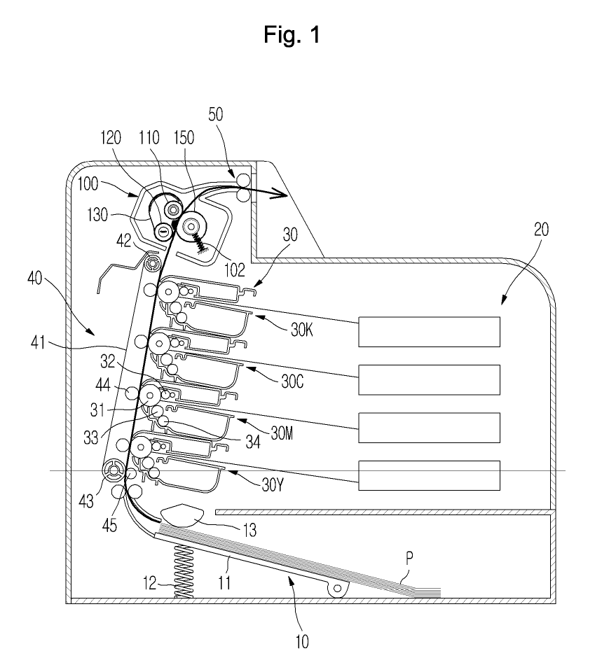

FIG. 1 is a sectional view illustrating units of an image forming apparatus in accordance with an embodiment of the present general inventive concept.

As illustrated in FIG. 1, the image forming apparatus according to an embodiment of the present general inventive concept includes a paper feeding unit 10, an exposure unit 20, a developing unit 30, a transfer unit 40, a fixing unit 100, and a discharge unit 50.

The paper feeding unit 10 to supply a paper P includes a paper tray 11 on which the paper P is loaded, and a spring 12 which elastically supports the paper tray 11. The paper P loaded on the paper tray 11 is picked up by a pickup roller 13 sheet by sheet, and moved toward the developing unit 30.

The developing unit 30 can include four toner cartridges 30Y, 30M, 30C and 30K, in which toners of different colors, e.g., yellow (Y), magenta (M), cyan (C) and black (K), are respectively contained. The respective toner cartridges 30Y, 30M, 30C and 30K are provided with photosensitive bodies 31 on which an electrostatic latent image is formed by the exposure unit 20. The exposure unit 20 irradiates light corresponding to image information of yellow (Y), magenta (M), cyan (C) and black (K) to the photosensitive body 31 of each toner cartridge according to a print signal.

As illustrated in FIG. 1, each of the toner cartridges 30Y, 30M, 30C and 30K includes a charge roller 32 to charge the photosensitive body 31, a developing roller 33 to develop the electrostatic latent image formed on each photosensitive body 31 to a visible image, and a supply roller 34 to supply the toner to the developing roller 33.

The transfer unit 40 is to transfer the toner image developed on the photosensitive body to the paper. The transfer unit 40 includes a transfer belt 41 which circulates while contacting the photosensitive bodies 31, a driving roller 42 which drives the transfer belt 41, a tension roller 43 which maintains a constant tensile force of the transfer belt 41, four transfer rollers 44 which transfer the toner image developed on the photosensitive bodies 31 onto the paper, and a transfer belt charge roller 45 which is in contact with the transfer belt 41 and charges the transfer belt 41. Four transfer rollers 44 are disposed oppositely to the corresponding photosensitive bodies 31 while interposing the transfer belt 41 therebetween, and the transfer belt charge roller 45 is disposed oppositely to the tension roller 43 while interposing the transfer belt 41 therebetween.

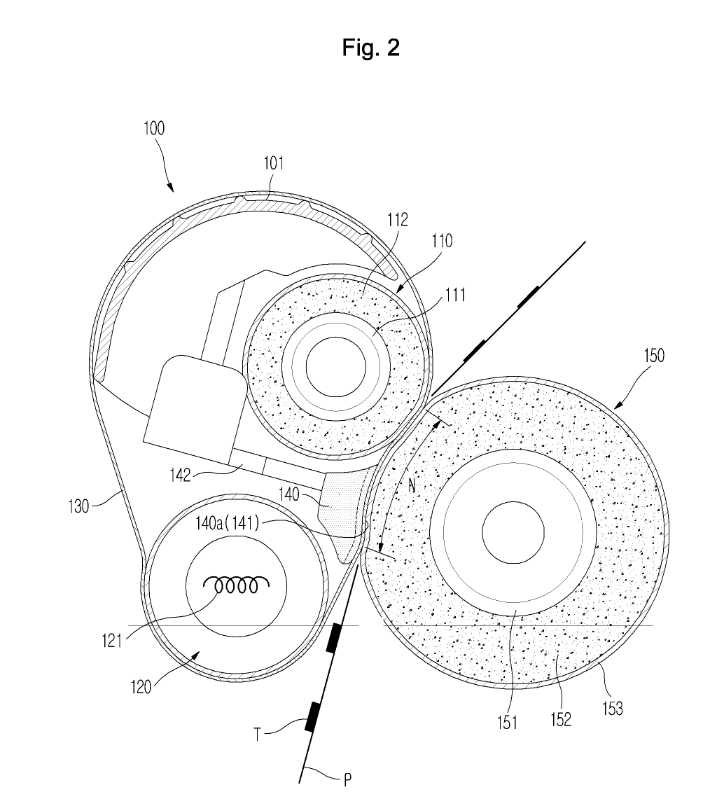

FIG. 2 is a sectional view illustrating a fixing unit 100 of the image forming apparatus illustrated in FIG. 1. As illustrated in FIG. 2, the fixing unit 100 fixes the toner image to the paper by applying heat and pressure to the paper. The fixing unit 100 includes a fixing belt 130 which is circulatingly supported by a driving roller 110 and a heat roller 120, a press member 140 which pressurizes a portion of the fixing belt 130 toward the paper P, and a press roller 150 which is in pressure contact with the driving roller 110 and the press member 140 while interposing the fixing belt 130 therebetween.

As illustrated in FIG. 2, outer circumferential surfaces of the driving roller 110 and the heat roller 120 contact an inner surface of the fixing belt 130. The driving roller 110 and the heat roller 120 support the fixing belt 130 with a belt guide member 101. In order to drive the fixing belt 130, the driving roller 110, for example, is connected to a driving source (not illustrated). The heat roller 120 contains a heat source 121 so as to heat the fixing belt 130. The heat source 121 of the heat roller 120 may include a halogen lamp, a hot wire or an induction heater.

The press member 140 is disposed between the driving roller 110 and the heat roller 120, and is supported by a supporting member 142 to be in close contact with the fixing belt 130 and pressurize the fixing belt 130 toward the paper P. The press member 140 is made of a material of, for example, a liquid crystal polymer added with teflon to improve lubrication. The press roller 150 is pressurized toward the fixing belt 130 by a press member 102 (see FIG. 1), and forms a fixing nip N between the press roller 150 and the fixing belt 130.

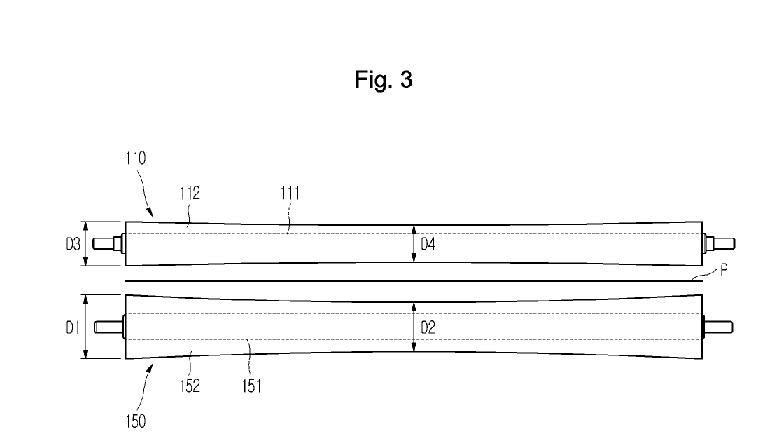

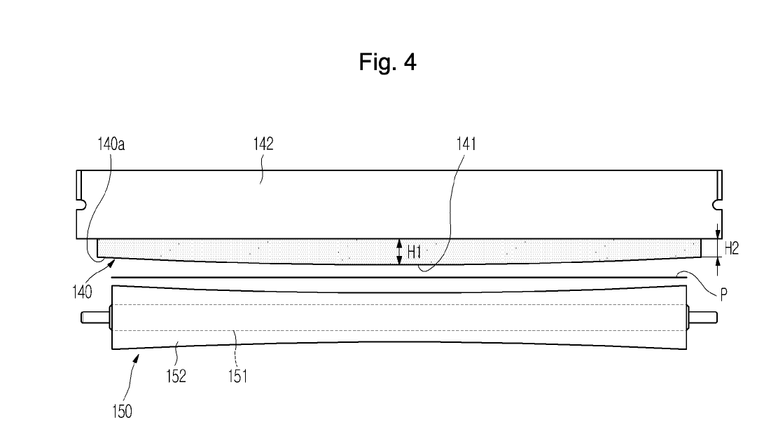

FIG. 3 is a plan view illustrating a press roller and a driving roller dismantled from the fixing unit illustrated in FIG. 2, and FIG. 4 is a plan view illustrating the press roller and a press member dismantled from the fixing unit illustrated in FIG. 2. In FIGS. 3 and 4, an illustration of the fixing belt is omitted.

As illustrated in FIGS. 2 and 3, the press roller 150 includes a shaft 151, for example, which is made of a metallic material such as aluminum or steel, and an elastic layer 152 which surrounds the shaft 151 and is elastically deformed to form a fixing nip N as the press roller 150 is in pressure contact with the driving roller 110 and the press member 140. The elastic layer 152, for example, is made of a silicon rubber, and covered with a release layer 153 to prevent the paper from sticking to the press roller 150.

In an embodiment of the present general inventive concept, the press roller 150 is formed in a concave shape. The concave shape may be a shape such that a diameter D1 of both ends of the press roller 150 is larger than a diameter D2 of a middle portion of the press roller 150. The press roller 150 having a concave shape allows a linear velocity of the paper contacting both end portions of the press roller 150 to be larger than a linear velocity of the paper contacting the middle portion of the press roller 150. Accordingly, paper is stretched in both side directions so slipping of the image or wrinkling of the paper can be prevented.

As with the press roller 150, the driving roller 110 may also include a metallic shaft 111 and an elastic layer 112 which surrounds the shaft 111. The elastic layer 112 of the driving roller 110 forms a fixing nip with the elastic layer 152 of the press roller 150. As with the press roller 150, the driving roller 110, for example, may also be formed in a concave shape. The driving roller 110 is configured such that a diameter D3 of both ends of the driving roller 110 is larger than a diameter D4 of a middle portion of the driving roller 110. Accordingly, slipping of the image or wrinkling of the paper can be more effectively prevented.

In an embodiment of the present general inventive concept, it has been described that both the press roller 150 and the driving roller 110 are formed in a concave shape. However, in another embodiment, only one of the rollers may be formed in a concave shape. Accordingly, the press roller 150 may be formed in a convex shape when forming only one of the rollers in a concave shape.

Alternatively, if both the press roller 150 and the driving roller 110 have a concave shape, the pressure exerted on the middle portion of the paper P may be decreased, thereby deteriorating the image fixing effect at the middle portion of the paper. Thus, in this embodiment, the shape of the press member 140 is modified so as to prevent the deterioration of the image fixing effect at the middle portion of the paper.

As illustrated in FIGS. 2 and 4, a pressure-contact surface 140a of the press member 140 which is in pressure contact with the press roller 150 is formed with a curved portion 141 which is convexly formed at the middle portion of the pressure-contact surface 140a. Accordingly, the pressure-contact surface 140a of the press member 140 is configured such that a height H1 of the middle portion is larger than a height H2 of both ends of the press member 140. Accordingly, the curved portion 141 formed at the middle portion of the pressure-contact surface 140a compensates for the fixing pressure, corresponding to the concave middle portion of the press roller 150, thereby preventing the deterioration of the image fixing effect at the middle portion of the paper.

Hereinafter, an operation of the image forming apparatus according to an embodiment of the present general inventive concept will be described with reference to FIGS. 2 to 4.

If a printing command is input to the image forming apparatus, the exposure unit 20 irradiates light corresponding to the image information of yellow, magenta, cyan and black to the photosensitive body 31 of each toner cartridge. If the light is irradiated to the photosensitive body 31, the electrostatic latent image is formed on the photosensitive body 31. The toner in each of the toner cartridges 30Y, 30M, 30C and 30K is supplied to the developing roller 33 by the supply roller 34, and the toner of the developing roller 33 is stuck to the electrostatic latent image formed on the photosensitive body 31, so that the toner image of yellow, magenta, cyan and black is formed on each photosensitive body 31.

As illustrated in FIG. 2, the paper picked up by the pickup roller 13 becomes adhered to the transfer belt 41 which is charged by the transfer belt charge roller 45 (see FIG. 1), and is fed at the same speed as the rotating speed of the transfer belt 41. If a voltage of an opposite polarity to the toner stuck to each photosensitive body 31 is applied to each transfer roller 44, the toner image formed on the photosensitive body 31 is transferred onto the paper P. Accordingly, as the paper P is fed, the toner image of yellow, magenta, cyan and black formed on each photosensitive body 31 is sequentially transferred one over another onto the paper P, so that the color toner image is perfectly formed on the paper P.

As illustrated in FIGS. 2 and 4, the paper P onto which the toner image T is transferred is moved to the fixing nip N, which is formed between the fixing belt 130 and the press roller 150. The heat generated from the heat source 121 of the heat roller 120 is transmitted to the paper P through the fixing belt 130, and heats the toner image T. Also, the paper P is pressed between the press member 140 and the press roller 150, and resultantly the toner image T is fixed to the paper P by the heat and the pressure. Since the curved portion 141 of the press member 140 compensates for the fixing pressure, corresponding to the concave middle portion of the press roller 150 having a concave shape, the deterioration of the image fixing effect at the middle portion of the paper can be prevented.

The paper P which has passed by the press member 140 is continuously heated and pressed between the driving roller 110 and the press roller 150, and the toner image T is fixed to the paper P. Since the press roller 150 and the driving roller 110 have a concave shape, wrinkling of the paper and slipping of the image can be prevented. The paper P which has undergone the above fixing process is then discharged to the exterior of the image forming apparatus by the discharge unit 50.

As described above, this embodiment of the present general inventive concept is structured such that the press roller 150 is pressurized toward the driving roller 110. However, in another embodiment of the present general inventive concept, the structure may be modified such that the press roller 150 is pressurized toward the heat roller 120.

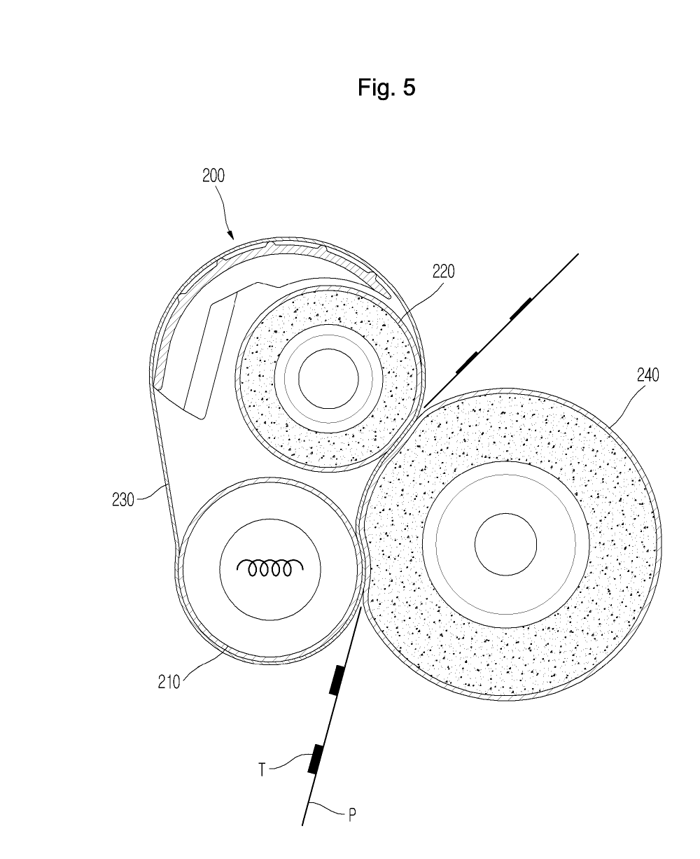

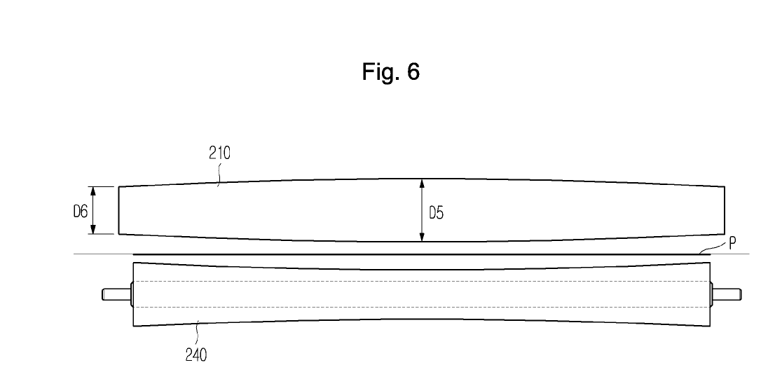

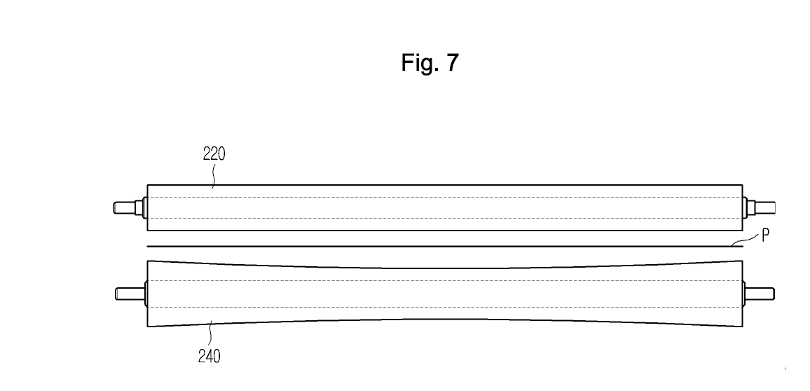

FIG. 5 is a sectional view illustrating a fixing unit 200 of an image forming apparatus in accordance with another embodiment of the present general inventive concept, FIG. 6 is a plan view illustrating a press roller 240 and a first roller 210 which is disposed upstream of a paper feeding direction while in pressure contact with the press roller 240 of the fixing unit 200 illustrated in FIG. 5, and FIG. 7 is a plan view illustrating the press roller 240 and a second roller 220 which is disposed downstream of the paper feeding direction with respect to the first roller 210 while in pressure contact with the press roller 240 of the fixing unit 200 illustrated in FIG. 5. In FIGS. 6 and 7, the illustration of the fixing belt is omitted.

As illustrated in FIG. 5, the fixing unit 200 of the image forming apparatus according to this embodiment of the present general inventive concept includes a fixing belt 230 which is supported by the first roller 210 and the second roller 220, and the press roller 240 which is in pressure contact with the first and second rollers 210 and 220 while interposing the fixing belt 230 therebetween.

As illustrated in FIGS. 5 and 6, the press roller 240 is formed in a concave shape to prevent wrinkling of the paper and slipping of the image. The first roller 210 is disposed upstream of the paper feeding direction with respect to, for example, the second roller 220. The first roller 210 is formed in a convex shape such that a diameter D5 of the middle portion is larger than a diameter D6 of both ends of the first roller 210. Therefore, the deterioration of the image fixing effect at the middle portion of the paper, which may be caused by the concave-shaped press roller 240, can be prevented.

As illustrated in FIG. 7, only the press roller 240 has a concave shape, and the second roller 220, which is disposed downstream of the paper feeding direction with respect to the first roller, has a straight shape (not convex or concave shape). However, similarly to the structure illustrated in FIG. 3, the second roller 220 may also have a concave shape.

As apparent from the above description, according to the image forming apparatus of various embodiments of the present general inventive concept, since a roller to form a fixing nip is formed in a concave shape, wrinkling of the paper or slipping of the image during the fixing process can be prevented. Also, by forming a curved portion of a press member or another roller to form a fixing nip in a convex shape, the decrease of the fixing pressure due to the concave-shaped roller can be prevented, thereby increasing the image fixing effect.

Although embodiments of the present general inventive concept have been illustrated and described, it would be appreciated by those skilled in the art that changes may be made in this embodiment without departing from the principles and spirit of the general inventive concept, the scope of which is defined in the claims and their equivalents.

What is claimed is:

1. An image forming apparatus comprising:
a fixing belt rotatably mounted;
a support roller in contact with an inner surface of the fixing belt to support the fixing belt;
a press member to pressurize a portion of the fixing belt toward a paper; and
a press roller in pressure contact with the support roller and the press member,
wherein at least one of the support roller and the press roller has a concave shape such that a diameter of both ends of the at least one of the support roller and the press roller is larger than a diameter of a middle portion thereof, and
the press member has a curved portion convexly formed at a middle portion thereof.

2. The image forming apparatus according to claim 1, further comprising:
a heat roller having a heat source to support the fixing belt together with the support roller,
wherein the press member is disposed between the support roller and the heat roller.

3. The image forming apparatus according to claim 1, wherein the support roller comprises a driving roller to drive the fixing belt.

4. An image forming apparatus comprising:
a fixing belt having an inner surface which is supported by a driving roller and a heat roller;
a press member disposed between the driving roller and the heat roller to pressurize a portion of the fixing belt toward a paper; and
a press roller in pressure contact with the driving roller and the press member, the fixing belt being positioned between the press roller and the driving roller and between the press roller and the press member,
wherein the press roller has a concave shape such that a diameter of both ends of the press roller is larger than a diameter of a middle portion thereof, and
the press member has a curved portion convexly formed at a middle portion thereof corresponding to the concave-shaped press roller.

5. The image forming apparatus according to claim 4, wherein the driving roller has a concave shape such that a diameter of both ends of the driving roller is larger than a diameter of a middle portion of the driving roller.

6. An image forming apparatus comprising:
a fixing belt rotatably supported by a first roller and a second roller; and
a press roller in pressure contact with the first roller and the second roller, the fixing belt being positioned between the press roller and the first and second rollers,
wherein the press roller has a concave shape such that a diameter of both ends of the press roller is larger than a diameter of a middle portion thereof, and
one of the first roller and the second roller, disposed upstream of a paper feeding direction with respect to the other of the first roller and the second roller, has a convex shape such that a diameter of a middle portion the one of the first roller and the second roller is larger than a diameter of both ends thereof.

7. The image forming apparatus according to claim 6, wherein the other one of the first roller and the second roller disposed downstream of the paper feeding direction of the one of the first roller and the second roller, has a concave shape such that a diameter of both ends the other one of the first roller and the second roller is larger than a diameter of a middle portion thereof.

8. A fixing apparatus comprising:
a roller having a concave shape so that a diameter of ends of the roller is larger than a diameter of a middle portion of the roller,
a member having a convex shape portion disposed opposite the roller that corresponds with the concave shape of the roller; and
a belt interposed between and contacting both the roller and the member to transport a recording medium between the roller and the member.

9. The apparatus according to claim 8, wherein the belt comprises a fixing belt to fix an image on the recording medium.

10. The apparatus according to claim 8, wherein the member comprises a press member to pressurize a portion of the belt toward the recording medium.

11. The apparatus according to claim 8, wherein the member comprises a support roller to movably support the belt.

12. The apparatus according to claim 11, wherein the support roller comprises a driving roller to drive the belt.

13. The apparatus according to claim 8, wherein the roller comprises a pressure roller in pressure contact with the member.

14. The apparatus according to claim 8, further comprising:
a support roller to moveably support the belt; and
a heat roller having a heat source to heat and moveably support the belt.

15. The apparatus according to claim 14, wherein the member is disposed between the heat roller and the support roller.

16. The apparatus according to claim 8, wherein the recording medium comprises paper.

17. An image forming apparatus comprising:
a frame;
a fixing apparatus disposed proximate to the frame, the fixing apparatus comprising:
a roller having a concave shape so that a diameter of ends of the roller is larger than a diameter of a middle portion of the roller,
a member having a convex shape portion deposed opposite the roller, the convex shape portion corresponding to the concave shape of the roller; and
a belt interposed between the roller and the member to transport the recording medium between the roller and the member.

18. An image forming apparatus comprising:
a press roller having a concave shape along a length thereof; and
a fixing belt rotatably mounted in pressing contact with the press roller at two portions thereof to receive a recording medium therebetween to fix a toner image on the recording medium, the fixing belt having a convex shape at one of the two portions thereof in a width direction extending along the length of the press roller to correspond with the concave shape of the press roller.

19. The apparatus according to claim 18, further comprising:
a first roller to support the fixing belt at one of the two portions; and
a second roller to support the fixing belt at the other one of the two portions;
wherein one of the first roller and the second roller having a convex shape along a length thereof to cause the fixing belt to have the convex shape in the width direction.
